(19) United States
(12) Patent Application Publication
(10) Pub. No.: US 2009/0285122 A1
(43) Pub. Date: Nov. 19, 2009

(54) UPLINK CONTROL FOR TIME-DIVISION DUPLEX WITH ASYMMETRIC ASSIGNMENT

(75) Inventors: Eko N. Onggosanusi, Allen, TX (US); Zukang Shen, Allen, TX (US); Tarik Muharemovic, Dallas, TX (US); Runhua Chen, Dallas, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 12/424,712

(22) Filed: Apr. 16, 2009

Related U.S. Application Data
(60) Provisional application No. 61/046,692, filed on Apr. 21, 2008.

(51) Int. Cl. H04L 12/28

(52) U.S. Cl. 370/254

(57) ABSTRACT

A link configuration unit includes a hybrid bundling module configured to provide a hybrid ACK/NAK bundling structure for an uplink ACK/NAK entity from user equipment, wherein the hybrid ACK/NAK bundling structure corresponds to an uplink-downlink configuration of subframe assignments. Additionally, the link configuration unit also includes a sending module configured to transmit the hybrid ACK/NAK bundling structure to the user equipment.

### CROSS-REFERENCE TO PROVISIONAL APPLICATION

This application claims the benefit of U.S. Provisional Application No. 61/046692, filed by Eko N. Onggosanusi, Zukang Shen, Tarik Muharemovic and Runhua Chen on Apr. 21, 2008, entitled “Uplink Control For TDD With Asymmetric Assignment” commonly assigned with this application and incorporated herein by reference.

### TECHNICAL FIELD

The present disclosure is directed, in general, to a communication system and, more specifically, to a link configuration unit, a link interpretation unit and methods of operating a link configuration unit or a link interpretation unit.

### BACKGROUND

A key principle in orthogonal frequency division multiple access (OFDMA) communication systems is that the total operating bandwidth is divided into non-overlapping sub-bands, also called resource blocks (RBs), where transmissions for user equipment (UE) occur in an orthogonal (i.e., not mutually interfering) manner. Each RB can potentially carry data to a different UE. More typically, each UE having a sufficiently high signal-to-interference and noise ratio (SINR) will use a well-chosen set of RBs, so that the spectral efficiency of the transmission is maximized according to the operating principle of a scheduler.

By scheduling each UE on RBs where it has high SINR, the data rate transmitted to each UE, and therefore the overall system throughput, can be optimized according to the scheduling principle. To enable more optimum frequency domain scheduling of UEs in the RBs of the operating bandwidth, each UE feeds back a channel quality indicator (CQI) it might potentially experience for each RB or each combination of RBs to its serving base station (Node B). A transmission rank indicator (RI) that determines the number of data layers multiplexed in the spatial domain is also fed back. Additionally, the UE provides an indication that a downlink transmission from its serving base station has been properly received in the form of an uplink transmission, which corresponds to the downlink transmission being acknowledged or negative-acknowledged as properly received (ACK/NAK). Although adequate, improvements in this area would prove beneficial in the art.

### SUMMARY

Embodiments of the present disclosure provide a link configuration unit, link interpretation unit and methods of operating a link configuration unit and a link interpretation unit. In one embodiment, the link configuration unit includes a hybrid bundling module configured to provide a hybrid ACK/NAK bundling structure for an uplink ACK/NAK entity from user equipment, wherein the hybrid ACK/NAK bundling structure corresponds to an uplink-downlink configuration of subframe assignments. Additionally, the link configuration unit also includes a sending module configured to transmit the hybrid ACK/NAK bundling structure to the user equipment.

In another embodiment, the link interpretation unit includes a receiving module configured to receive a hybrid ACK/NAK bundling structure from a base station. The link interpretation unit also includes a configuration reporting module configured to provide the hybrid ACK/NAK bundling structure for feeding back a corresponding uplink ACK/NAK entity to the base station, wherein the hybrid ACK/NAK bundling structure corresponds to an uplink-downlink configuration of subframe assignments.

In another aspect, the method of operating a link configuration unit includes providing a hybrid ACK/NAK bundling operation for an uplink ACK/NAK entity from user equipment, wherein the hybrid ACK/NAK bundling operation corresponds to an uplink-downlink configuration of subframe assignments. The method also includes transmitting the hybrid ACK/NAK bundling operation to the user equipment.

In yet another aspect, the method of operating a link interpretation unit includes receiving a hybrid ACK/NAK bundling operation from a base station and providing the hybrid ACK/NAK bundling operation for feeding back a corresponding uplink ACK/NAK entity to the base station, wherein the hybrid ACK/NAK bundling operation corresponds to an uplink-downlink configuration of subframe assignments.

The foregoing has outlined preferred and alternative features of the present disclosure so that those skilled in the art may better understand the detailed description of the disclosure that follows. Additional features of the disclosure will be described hereinafter that form the subject of the claims of the disclosure. Those skilled in the art will appreciate that they can readily use the disclosed conception and specific embodiment as a basis for designing or modifying other structures for carrying out the same purposes of the present disclosure.

### BRIEF DESCRIPTION OF THE DRAWINGS

For a more complete understanding of the present disclosure, reference is now made to the following descriptions taken in conjunction with the accompanying drawings, in which:

FIGS. 1A and 1B illustrate diagrams of a downlink portion and an uplink portion of a communications system as provided by one embodiment of the disclosure;

FIG. 2 illustrates a hybrid concept of ACK/NAK transmission constructed according to the principles of the present disclosure;

FIG. 3 illustrates a first example of bundling for spatial multiplexing wherein four DL subframes and a bundling window length of two are assumed;

FIGS. 4A and 4B illustrate second and third examples of bundling for spatial multiplexing wherein four DL subframes and a bundling window length of two are again assumed;

FIG. 5 illustrates a fourth example of bundling for spatial multiplexing which occurs across codewords but not across subframes;

FIGS. 6A and 6B illustrate fifth and sixth examples of bundling for spatial multiplexing which occurs across both codewords and subframes;

FIG. 7 illustrates a flow diagram of a method of operating a link configuration unit carried out according to the principles of the present disclosure; and

FIG. 8 illustrates a flow diagram of a method of operating a link interpretation unit carried out according to the principles of the present disclosure.

### DETAILED DESCRIPTION

Currently, E-UTRA LTE supports seven different Uplink-Downlink (UL-DL) configurations for time-division duplex (TDD). As may be seen in Table 1 below, DL resource assignment is notably heavier than UL resource assignment. In fact, four out of seven UL-DL configurations assign over fifty percent more resource for DL than UL. Such asymmetric assignment results in a deficit in terms of UL control resources especially for the UL Acknowledged/Negative-Acknowledged (ACK/NAK), which facilitates DL HARQ operation.

TABLE 1
UL-DL Configuration Supported by TDD (LTE)
[D = downlink, U = uplink, S = special subframe (DwPTS + GS + UpPTS)]

| Uplink- | Switch- | | | | | | | | | | | |
|---|---|---|---|---|---|---|---|---|---|---|---|---|
| Downlink | point | | Subframe number | | | | | | | | | |
| Configuration | Periodicity | UL-DL Split | 0 | 1 | 2 | 3 | 4 | 5 | 6 | 7 | 8 | 9 |
| 0 | 5 ms | 2DL:2S:6UL → 4DL:6UL | D | S | U | U | U | D | S | U | U | U |
| 1 | 5 ms | 4DL:2S:4UL → 6DL:4UL | D | S | U | U | U | D | S | U | U | D |
| 2 | 5 ms | 6DL:2S:2UL → 8DL:2UL | D | S | U | U | U | D | S | U | D | D |
| 3 | 10 ms | 6DL:1S:3UL → 7DL:3UL | D | S | U | U | U | D | S | U | D | D |
| 4 | 10 ms | 7DL:1S:2UL → 8DL:2UL | D | S | U | U | U | D | S | U | D | D |
| 5 | 10 ms | 8DL:1S:1UL → 9DL:1UL | D | S | U | U | U | D | S | U | D | D |
| 6 | 5 ms | 3DL:2S:5UL → 5DL:5UL | D | S | U | U | U | D | S | U | U | D |

ACK/NAK bundling may be applied to reduce the number of ACK/NAK entities, thereby increasing the ACK/NAK coverage. Here, ACK/NAK bundling is defined as transmitting only one UL ACK/NAK entity corresponding to several DL assignments to a given user equipment (UE) in one UL subframe. This, however, increases the retransmission probability for larger bundling window length which may severely impact the system throughput. Note that one ACK/NAK entity consists of one bit for a 1-layer transmission and two bits for spatial multiplexing having greater than one layer.

Therefore, whenever coverage is not an issue, ACK/NAK bundling is typically not employed. Rather, multiple ACK/NAK entities (each corresponding to one DL assignment to a given UE) may be transmitted in one UL subframe. This may be termed multi-ACK/NAK or ACK/NAK multiplexing. In this case, a new transmission format may need to be defined, especially when ACK/NAK is multiplexed with CQI (including PMI and RI).

Table 2 shows the maximum number of UL ACK/NAK entities from a UE for each UL subframe, assuming that one ACK/NAK is transmitted for each DL assignment. Notice that the possible values are {0,1,2,3,4,9}. One may observe that both ACK/NAK bundling and multi-ACK/NAK are not needed for configurations 0 and 6. Additionally for configuration 0, some UL subframes will not carry UL ACK/NAK transmissions.

TABLE 2
Latency and Maximum Number of ACK/NAKs

| Uplink- | | | | | | | | | | | Maximum number of ACK/NAK | | | | | | | | | |
|---|---|---|---|---|---|---|---|---|---|---|---|---|---|---|---|---|---|---|---|---|
| Downlink | Latency: Subframe n | | | | | | | | | | Entities: Subframe n | | | | | | | | | |
| Configuration | 0 | 1 | 2 | 3 | 4 | 5 | 6 | 7 | 8 | 9 | 0 | 1 | 2 | 3 | 4 | 5 | 6 | 7 | 8 | 9 |
| 0 | 4 | 6 | — | — | — | 4 | 6 | — | — | — | — | — | 1 | 0 | 1 | — | — | 1 | 0 | 1 |
| 1 | 7 | 6 | — | — | 4 | 7 | 6 | — | — | 4 | — | — | 2 | 1 | — | — | — | 2 | 1 | — |
| 2 | 7 | 6 | — | 4 | 8 | 7 | 6 | — | 4 | 8 | — | — | 4 | — | — | — | — | 4 | — | — |
| 3 | 4 | 11 | — | — | — | 7 | 6 | 6 | 5 | 5 | — | — | 3 | 2 | 2 | — | — | — | — | — |
| 4 | 12 | 11 | — | — | 8 | 7 | 7 | 6 | 5 | 4 | — | — | 4 | 4 | — | — | — | — | — | — |
| 5 | 12 | 11 | — | 9 | 8 | 7 | 6 | 5 | 4 | 13 | — | — | 9 | — | — | — | — | — | — | — |
| 6 | 7 | 7 | — | — | — | 7 | 7 | — | — | 5 | — | — | 1 | 1 | 1 | — | — | 1 | 1 | — |

Embodiments of the present disclosure provide UL ACK/NAK components to ensure an efficient UL control operation for TDD having potentially asymmetric UL-DL assignments. To ensure a flexible trade-off between ACK/NAK coverage and system throughput, hybrid ACK/NAK bundling and multi-ACK/NAK are supported. Another challenge associated with multi-ACK/NAK transmission is a transmission format when ACK/NAK is multiplexed with CQI. Due to the increased number of bits for multi-ACK/NAK transmission, a new format with an efficient resource allocation is required.

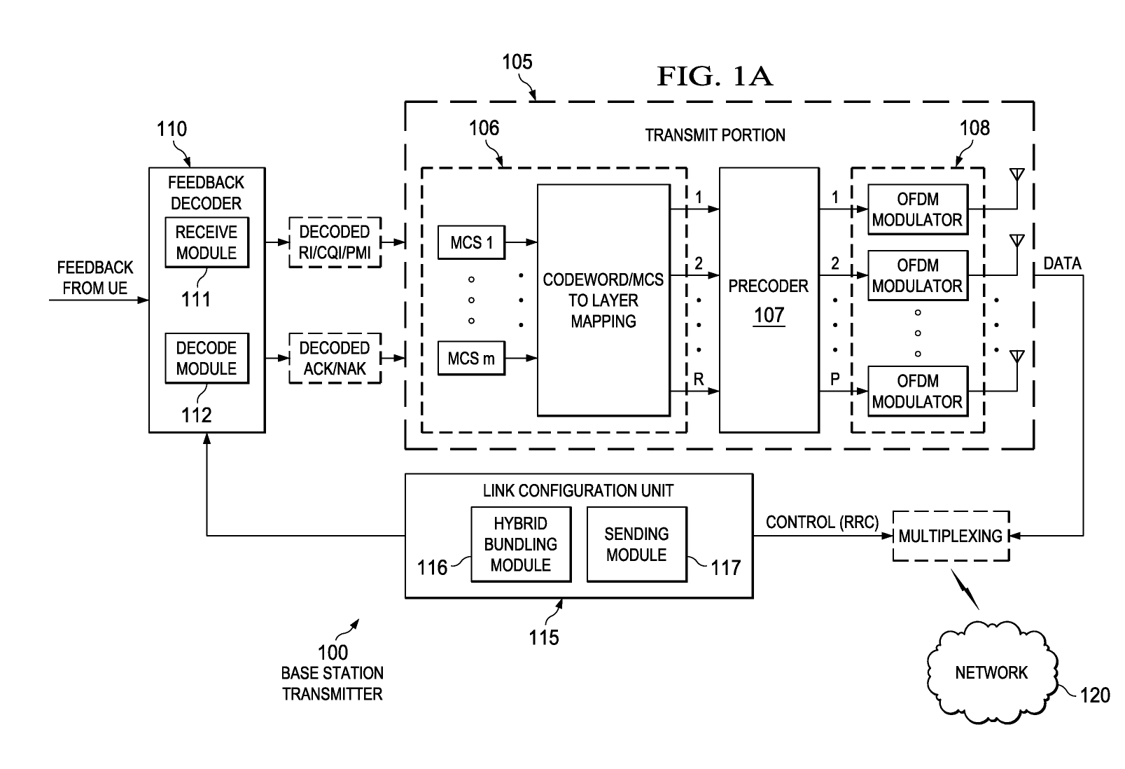

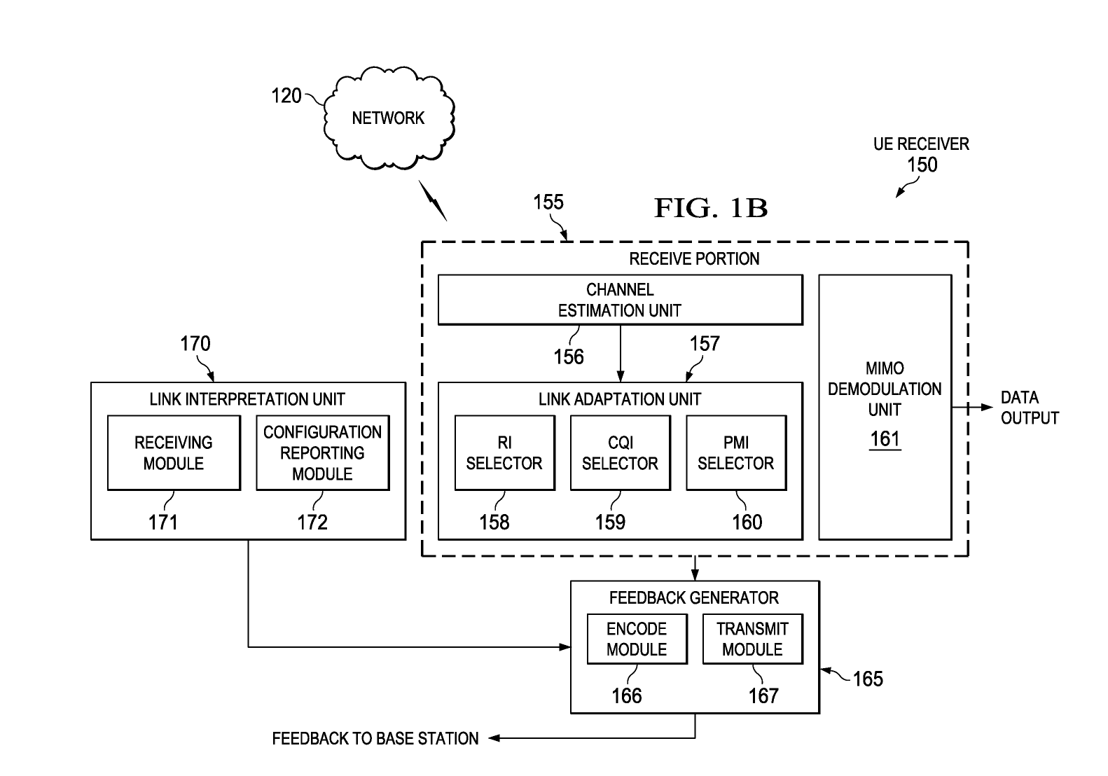

FIGS. 1A and 1B illustrate diagrams of a downlink portion 100 and an uplink portion 150 of a communications system as provided by one embodiment of the disclosure. In the illustrated embodiment, the communications system is an orthogonal frequency division multiple access (OFDMA) system, which provides a total operating bandwidth divided into non-overlapping RBs. The RBs provide transmissions for different UEs that occur in an orthogonal or substantially independent manner wherein each RB can potentially carry data to a different UE.

FIG. 1A illustrates a system diagram of the downlink portion 100, which corresponds to a base station transmitter (Node B) and includes a transmit portion 105, a feedback decoder 110 and a link configuration unit 115. The transmit portion 105 includes a modulation and coding scheme (MCS) module 106, a precoder module 107 and an OFDM module 108 having multiple OFDM modulators that feed corresponding transmit antennas.

The feedback decoder 110 includes a receive module 111 and a decode module 112. The receive module 111 receives transmission rank indicator (RI) and channel quality indicator (CQI) information as well as precoding matrix indicator (PMI) selections that have been fed back from user equipment. The decoding module 112 extracts the RI, CQI and PMI selections wherein they are provided to the transmit portion 105 to allow efficient data transmission over multiple antennas through a communication network 120.

The MCS module 106 employs the RI selection to map input data to indicated spatial streams (1-R). A scheduling function (not specifically shown) employs the CQI selection to assign RBs to each of the user equipment. The precoder module 107 then maps the spatial streams linearly into output data streams for transmission by the OFDM module 108 over the communication network 120.

The link configuration unit 115 includes a hybrid bundling module 116 and a sending module 117. The hybrid bundling module 116 is configured to provide a hybrid ACK/NAK bundling structure for an uplink ACK/NAK entity from a UE, wherein the hybrid ACK/NAK bundling structure corresponds to an uplink-downlink configuration of subframe assignments. The sending module 117 is configured to transmit the hybrid ACK/NAK bundling structure to the UE. The hybrid ACK/NAK bundling is sent by a radio resource control (RRC) channel through the communication network 120 to inform the UE of the structure to be used to acquire the uplink ACK/NAK entity, which is then fed back to the Node B. The hybrid ACK/NAK bundling is also provided to the feedback decoder 110 for decoding the uplink ACK/NAK entity, which is employed for transmission control purposes.

FIG. 1B illustrates a system diagram of the uplink portion 150 as provided by one embodiment of the disclosure. In the illustrated embodiment, the uplink portion 150 corresponds to a UE receiver and includes a receive portion 155, a feedback generator 165 and a link interpretation unit 170. The receive portion 155 includes a channel estimation unit 156, a link adaptation unit 157 and a MIMO demodulation unit 161.

The receive portion 155 is primarily employed to receive data signals from a transmission corresponding to RI, CQI and PMI information wherein the MIMO demodulation unit 161 ultimately provides data output. The channel estimation unit 156 employs previously transmitted channel estimation signals to provide the channel estimates need by the receive portion 155. The link adaptation unit 157 includes an RI selector 158, a CQI selector 159 and a PMI selector 160. The rank selector 158 provides a transmission rank selection. The CQI selector 159 provides a channel quality based on channel estimation and the preceding selector 160 provides a preceding matrix selection.

The feedback generator 165 includes an encode module 166 and a transmit module 167. The encode module 166 accepts the rank, channel quality and preceding matrix selections from the link adaptation unit 157 and encodes them for feeding back to the Node B. Additionally, the encode module 166 accepts an uplink ACK/NAK entity to be fed back. The transmit module 167 then feeds back these parameters to the downlink portion 100.

The link interpretation unit 170 includes a receiving module 171 and a configuration reporting module 172. The receive module 171 is configured to receive a hybrid ACK/NAK bundling structure from the Node B. Additionally, the configuration reporting module 172 is configured to provide the hybrid ACK/NAK bundling structure for feeding back a corresponding uplink ACK/NAK entity to the Node B, wherein the hybrid ACK/NAK bundling structure corresponds to an uplink-downlink configuration of subframe assignments.

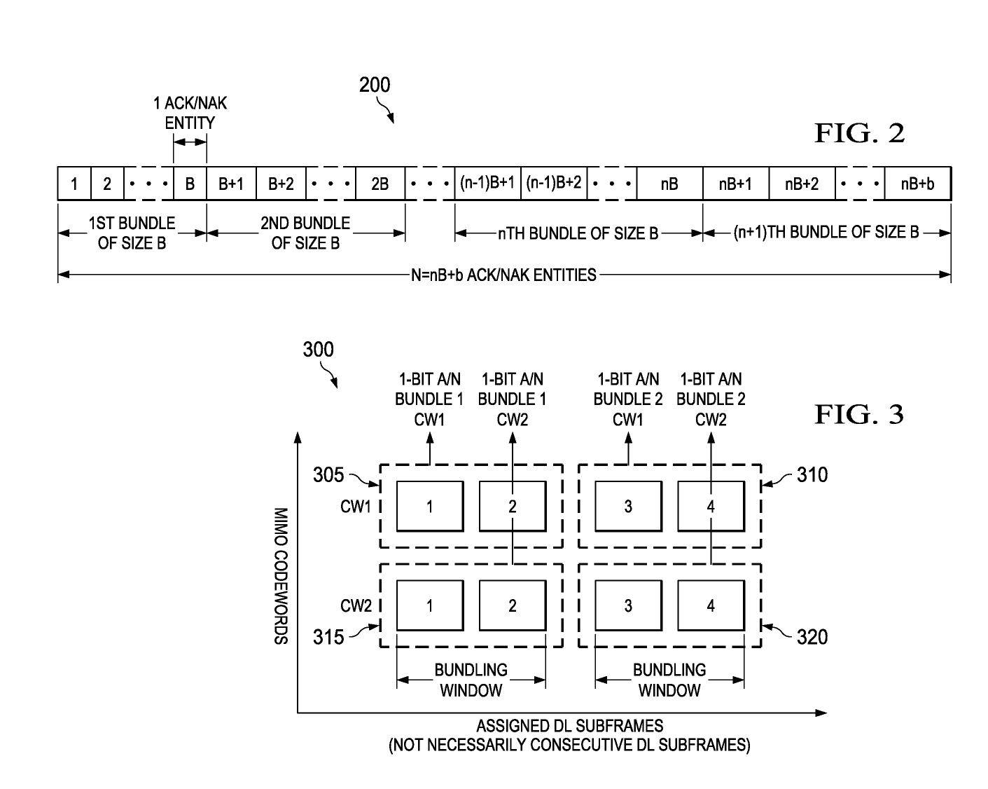

FIG. 2 illustrates a hybrid concept of ACK/NAK transmission, generally designated 200, constructed according to the principles of the present disclosure. The hybrid concept of ACK/NAK transmission 200 may include different bundling window lengths Bε{1,2, . . . , M} or a subset thereof to reduce the number of options supported. Here, M is the maximum number of ACK/NAK transmissions for a given UL-DL configuration and subframe, where this holds only when M is greater than one. The set of possible bundling window lengths is made configuration-specific and subframe specific.

The assignment of UL ACK/NAK resources can be done as follows. Assume that there are N=Bn+b DL assignments associated with a given UL subframe, where

$$b = mod ( N , B ) , n = ⌈ \frac{N}{B} ⌉ ,$$

and N≦M. When a bundling window of length B is selected, the first B DL assignments are bundled (i.e., grouped) for one UL ACK/NAK entity. Then, the remaining (n−1) bundles (groups) associated with (n−1) ACK/NAK entities are transmitted accordingly with the same bundling window length B. Finally, the last b DL assignments are grouped and associated with the last ACK/NAK entity. Note that pure ACK/NAK bundling corresponds to B=M where no bundling (pure multi-ACK/NAK) corresponds to B=1 regardless of the number of DL assignments associated with a given UL subframe.

The choice of bundling window length B is a semi-static setup. It can be made either UE-specific (e.g., via a dedicated RRC signaling or parameter) or cell-specific (e.g., via a broadcast parameter in P-BCH or SU-1). A UE-specific setup may be more efficient since the choice of B is strongly correlated with the UE geometry or location. Such signaling is needed only when B can take more than one value (configuration 1, 2, 3, 4 or 5). The bundling window length may be specified for each of the UL subframe numbers, which supports UL ACK/NAK transmission (subframes 3 and 8 of configuration 0 do not support UL ACK/NAK transmission due to the imposed latency constraint).

For each UL ACK/NAK entity, the resource for ACK/NAK transmission is determined by the last DL assignment within each of the (n+1) bundles. Hence, there are (n+1) parameters that can be used to determine the UL ACK/NAK resource allocation.

For a given bundling window length value of B̅, UE can bundle up to B̅ DL assignments for one UL ACK/NAK entity. That is, the final bundle size depends on the number of DL assignments. For example, if B̅=2 and the number of DL assignments is five, three ACK/NAK entities with bundle sizes of two, two and one are composed. The intent of defining the bundling window length is to limit the number of ACK/NAK entities. This assumes that missed DL assignments can be reliably detected (e.g., via toggling an indicator for consecutive DL assignments or using some type of counter).

The set of all possible bundling window lengths for each combination of UL-DL allocation and subframe number is given in Table 3A below. To reduce the number of options, it is possible to further constraint the set into a smaller subset especially when the maximum number of ACK/NAK transmissions is large. For instance, {1,2,3} or {1,2,4} can be used in place of {1,2,3,4} for configurations 2 and 4. Also, {1,3,5,9} may be used instead of {1,2,3,4,5,6,7,8,9} for configuration 6.

TABLE 3A
Set of Possible Bundling Window Lengths
(Full Set)

| Uplink- | | | | | | | | | | |
|---|---|---|---|---|---|---|---|---|---|---|
| downlink | Set of possible bundling window lengths: Subframe n | | | | | | | | | |
| Configuration | 0 | 1 | 2 | 3 | 4 | 5 | 6 | 7 | 8 | 9 |
| 0 | — | — | {1} | { } | {1} | — | — | {1} | { } | {1} |
| 1 | — | — | {1, 2} | {1} | — | — | — | {1, 2} | {1} | — |
| 2 | — | — | {1, 2, 3, 4} | — | — | — | — | {1, 2, 3, 4} | — | — |
| 3 | — | — | {1, 2, 3} | {1, 2} | {1, 2} | — | — | — | — | — |
| 4 | — | — | {1, 2, 3, 4} | {1, 2, 3, 4} | — | — | — | — | — | — |
| 5 | — | — | {1, 2, 3, 4, 5, 6, 7, | — | — | — | — | — | — | — |
| | | | 8, 9} | | | | | | | |
| 6 | — | — | {1} | {1} | {1} | — | — | {1} | {1} | — |

Table 3B provides an example of a reduced set of bundling window lengths where up to three possible values are allowed for each combination of UL-DL allocation and subframe number. In this setup, maximum bundling is allowed. For configuration 6, it is also possible to limit the maximum bundling window length further to avoid excessive increase in transmission probability. For example, {1,3,5} may be chosen instead of {1,3,5,9}. It is also possible to impose some type of scheduler restriction to either limit the maximum number of assigned DL subframes for each UE (e.g., to four or five) or limit the number of UEs that are simultaneously scheduled in each DL subframe. In that case, the bundling window length of nine can be removed.

TABLE 3B
Set of Possible Bundling Window Lengths
(Reduced Set 1)

| Uplink- | | | | | | | | | | |
|---|---|---|---|---|---|---|---|---|---|---|
| Downlink | Set of possible bundling window lengths: Subframe n | | | | | | | | | |
| Configuration | 0 | 1 | 2 | 3 | 4 | 5 | 6 | 7 | 8 | 9 |
| 0 | — | — | {1} | { } | {1} | — | — | {1} | { } | {1} |
| 1 | — | — | {1, 2} | {1} | — | — | — | {1, 2} | {1} | — |
| 2 | — | — | {1, 2, 4} | — | — | — | — | {1, 2, 4} | — | — |
| 3 | — | — | {1, 2, 3} | {1, 2} | {1, 2} | — | — | — | — | — |
| 4 | — | — | {1, 2, 4} | {1, 2, 4} | — | — | — | — | — | — |
| 5 | — | — | {1, 3, 5, 9} | — | — | — | — | — | — | — |
| 6 | — | — | {1} | {1} | {1} | — | — | {1} | {1} | — |

Table 3C gives yet another example where the number of options is further reduced by removing a bundling window length of one for configurations with significant asymmetry (i.e., configurations 2, 3, 4 or 5). In this case, the maximum number of ACK/NAK entities per subframe is three for configuration 5 and two for other configurations. If limiting the maximum number of ACK/NAK entities to two, {5,9} can be used instead of {3,9} for configuration 5. At the same time, if the maximum number of assigned DL subframes per UE is limited to four or five, for example, the following set of {2,4} for a maximum of four DL subframes per UE and {3,5} for a maximum of five DL subframes per UE may be used.

TABLE 3C
Set of Possible Bundling Window Lengths
(Reduced Set 2)

| | Set of Possible Bundling Window Lengths: | | | | | | | | | |
|---|---|---|---|---|---|---|---|---|---|---|
| Uplink-Downlink | Subframe n | | | | | | | | | |
| Configuration | 0 | 1 | 2 | 3 | 4 | 5 | 6 | 7 | 8 | 9 |
| 0 | — | — | {1} | { } | {1} | — | — | {1} | { } | {1} |
| 1 | — | — | {1, 2} | {1} | — | — | — | {1, 2} | {1} | — |
| 2 | — | — | {2, 4} | — | — | — | — | {2, 4} | — | — |
| 3 | — | — | {2, 3} | {2} | {2} | — | — | — | — | — |
| 4 | — | — | {2, 4} | {2, 4} | — | — | — | — | — | — |
| 5 | — | — | {3, 9} | — | — | — | — | — | — | — |
| 6 | — | — | {1} | {1} | {1} | — | — | {1} | {1} | — |

Note that different subframes may have different sets (e.g., configurations 0, 1, and 3). Since the set is a fixed configuration and does not need to be signaled, this may be accommodated in a straightforward manner.

FIG. 3 illustrates a first example of bundling for spatial multiplexing, generally designated 300, wherein four DL subframes and a bundling window length of two are assumed. Each bundle represents one ACK/NAK entity, and all DL subframes are assigned two spatial codewords. The first example of spatial multiplexing 300 includes first and second bundles 305, 310 for codeword one (CW1) and third and fourth bundles 315, 320 for codeword 2 (CW2 ). Note that each spatial codeword is associated with a distinct transport block.

The ACK/NAK bundling is performed across subframes (i.e., in the time domain). Due to the support of dynamic rank adaptation for spatial multiplexing, the number of MIMO codewords (transmission layers) scheduled for each UE can vary within the bundles of DL subframes. When all the bundled DL subframes are assigned to more than one layer, each ACK/NAK entity consists of two bits with each corresponding to one codeword. Hence, the ACK/NAK bundling can be performed across subframes for each codeword.

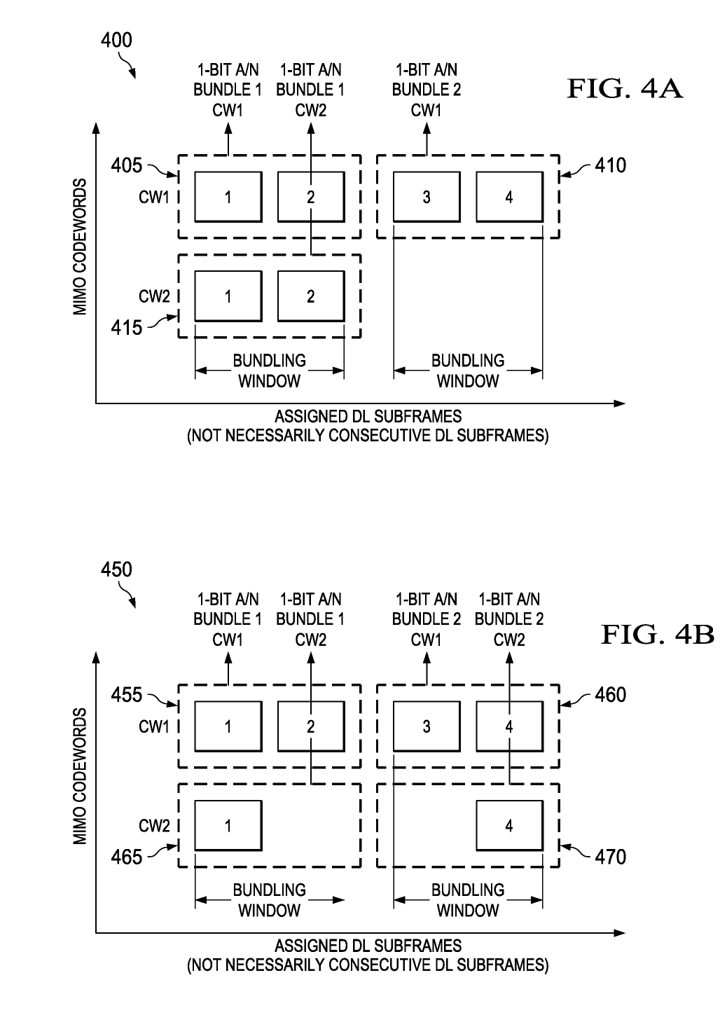

FIGS. 4A and 4B illustrate second and third examples of bundling for spatial multiplexing, generally designated 400, 450, wherein four DL subframes and a bundling window length of two are again assumed. Each bundle also represents one ACK/NAK entity, and there are a varying number of codewords across the DL subframes.

In FIG. 4A, the second example of bundling for spatial multiplexing 400 includes first and second bundles 405, 410 for codeword one (CW1) and a third bundle 415 for codeword two (CW2). Each of the first and second bundles 405, 410 for CW1 contain two subframes as does the third bundle 415 for CW2.

In FIG. 4B, the third example of bundling for spatial multiplexing 450 includes first and second bundles 455, 460 for codeword one (CW1) and third and fourth bundles 465, 470 for codeword two (CW2). Each of the first and second bundles 455, 460 for CW1 may be seen to contain two subframes, while each of the third and fourth bundles 465, 470 for CW2 contain a single subframe.

When the number of layers varies across the assigned DL subframes such that the number of codewords varies between one and two, the same bundling window length is used for each codeword. Here, the bundling window length is defined in terms of the maximum number of bundled DL subframes that are assigned to the UE irrespective of the number of codewords per DL subframe. In this case, the final bundle size may be different between the two codewords depending on how the number of layers varies across the assigned DL subframes.

It is possible to allow different sets for one bit per ACK/NAK entity and two bits per ACK/NAK entity. This may be intended to keep the maximum number of ACK/NAK bits the same regardless of the transmission scheme (e.g., 1-layer or 2-layer spatial multiplexing). This principle may be applied for all configurations or only to some UL-DL configurations. In this case, it is possible to assign two different bundling window lengths: one for one bit per ACK/NAK entity and the other for two bits per ACK/NAK entity. However, this approach may result in some difficulty when dynamic rank adaptation and bundling across subframes are employed as apparent from the previous discussion.

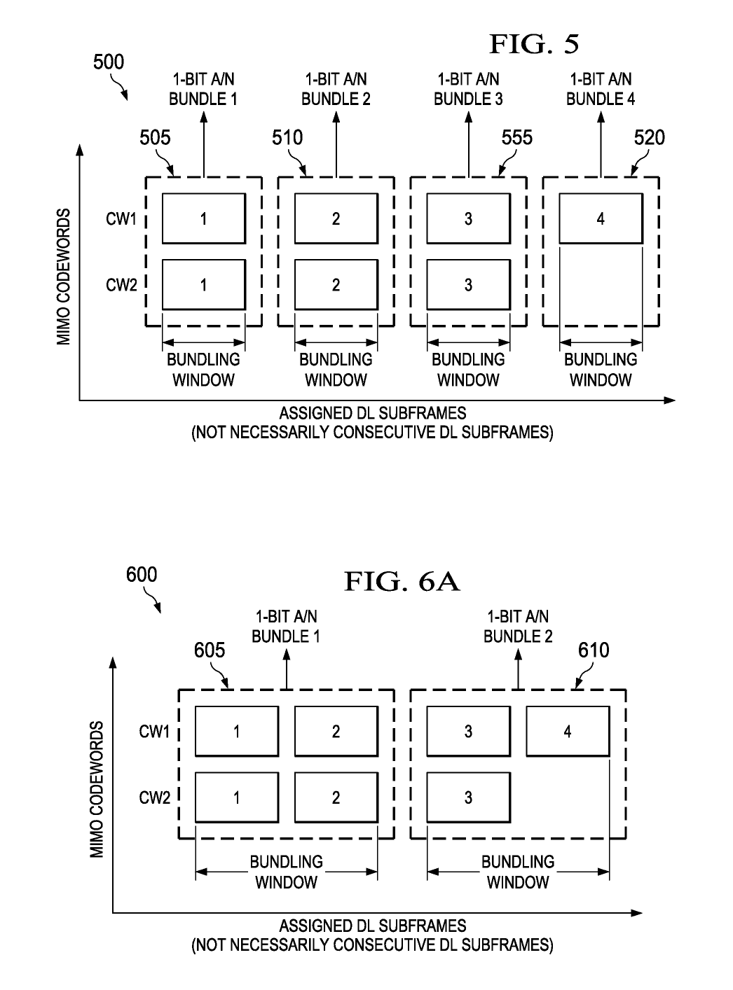

FIG. 5 illustrates a fourth example of bundling for spatial multiplexing, generally designated 500, which occurs across codewords but not across subframes. Four DL subframes and a bundling window length of one are employed for codeword one (CW1), and three corresponding DL subframes are employed for codeword two (CW2) in the first three bundles, as shown. The fourth bundle includes only the subframe for CW1. Again, each bundle represents one ACK/NAK entity, which consists of at most one bit.

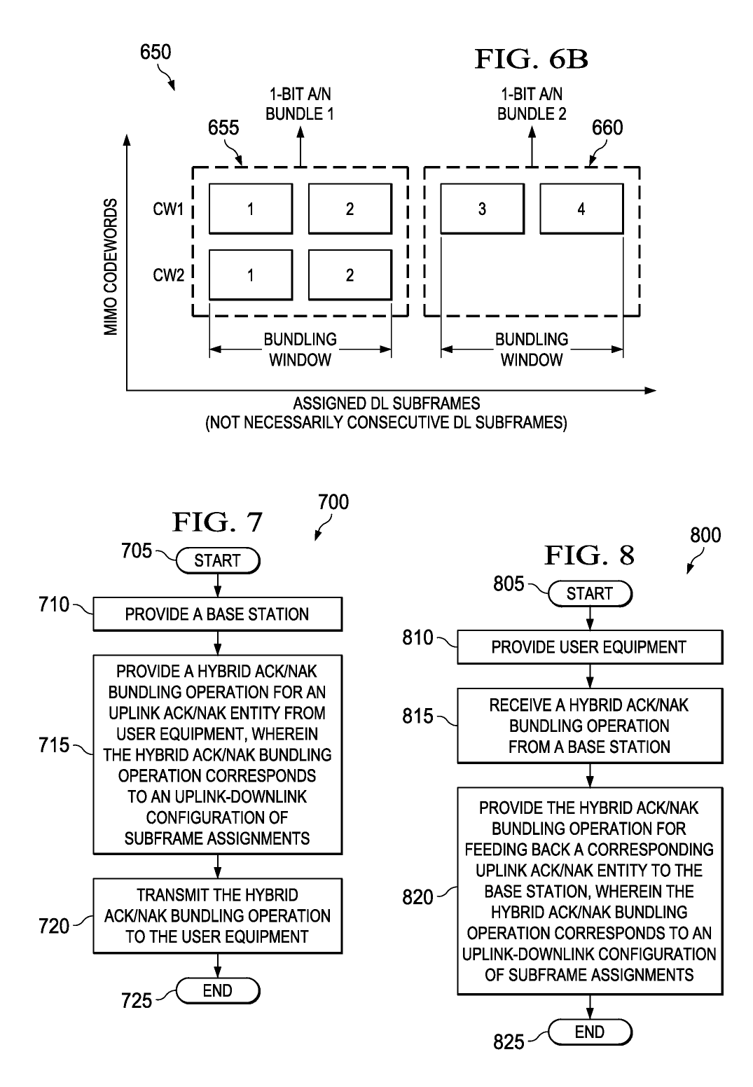

FIGS. 6A and 6B illustrate fifth and sixth examples of bundling for spatial multiplexing, generally designated 600, 650, which occurs across both codewords and subframes.

In FIG. 6A, the fifth example of bundling for spatial multiplexing 600 includes first and second bundles 605, 610 for codeword one (CW1) and codeword two (CW2 ). Each of the first and second bundles 605, 610 for CW1 contain two subframes as does the first bundle 605 for CW2. However, the second bundle 610 contains only one subframe for CW2. Each bundle represents one ACK/NAK entity, which consists of at most one bit.

In FIG. 6B, the sixth example of bundling for spatial multiplexing 650 includes first and second bundles 655, 660 for codeword one (CW1) and codeword 2 (CW2). Each of the first and second bundles 655, 660 for CW1 contain two subframes as does the first bundle 655 for CW2. However, the second bundle 600 contains no subframes for CW2. Again, each bundle represents one ACK/NAK entity, which consists of at most one bit.

Generally referring again to FIGS. 1A and 1B, the following design aspects may be considered to provide a UL control signaling format. The formats for ACK/NAK and CQI transmissions need to be considered together to allow efficient multiplexing between the two. This includes the concurrent transmission of ACK/NAK and CQI. While CQI can be dropped when ACK/NAK transmission occurs, this is done even more judiciously for TDD due to the extra restriction in CQI reporting. Here, CQI may also encompass PMI or RI for spatial multiplexing.

SRI (scheduling request indicator) may also need to be considered, as well. While having a common format for all TDD configurations seems attractive, this is typically inefficient due to the different asymmetry of the UL-DL allocation for different configurations. Hence, choosing different formats for different UL-DL configurations is justified. If the bundling window length is UE-specific, one needs to ensure that the UL control transmission (ACK/NAK and CQI) from different UEs can be multiplexed efficiently.

Guided by the above design aspects, the following UL control design principles may be employed. Starting with the setup in Table 3C with {3,9} or {5,9} for configuration 5, there are a maximum of 3 or 2 ACK/NAK entities, respectively. This corresponds to a maximum of 3 or 2 bits for a single-antenna, 1-layer spatial multiplexing or transmission diversity, and 6 or 4 bits for greater than 1-layer spatial multiplexing.

For configurations with symmetric UL-DL allocation (configurations 0 and 6), it is reasonable to simply reuse the existing UL control formats for FDD. This is because multi-ACK/NAK transmission is not needed. For other configurations, reusing the existing FDD formats may not be feasible, especially when ACK/NAK is multiplexed with CQI (which may cause coverage problems).

To ensure sufficient coverage for both CQI and ACK/NAK, it is proposed to increase capacity by extended support of greater than 20 bits for each PUCCH allocation. Some examples include the use of multiple cyclic shifts per allocation for a CAZAC-based scheme as well as a DFT-spread OFDM-based scheme.

FIG. 7 illustrates a flow diagram of a method of operating a link configuration unit, generally designated 700, carried out according to the principles of the present disclosure. The method 700 is for use with a base station and starts in a step 705. Then, in a step 710, the base station is provided and a hybrid ACK/NAK bundling operation for an uplink ACK/NAK entity from user equipment is provided, in a step 715, wherein the hybrid ACK/NAK bundling operation corresponds to an uplink-downlink configuration of subframe assignments. The hybrid ACK/NAK bundling operation is transmitted to the user equipment, in a step 720.

Generally, the hybrid ACK/NAK bundling consists of a pure ACK/NAK bundling, a pure multi-ACK/NAK or a combination of ACK/NAK bundling and multi-ACK/NAK. In one embodiment, an ACK/NAK bundling window is performed across downlink subframes corresponding to a single spatial codeword. In another embodiment, an ACK/NAK bundling window is performed across spatial codewords for single corresponding downlink subframes. In yet another embodiment, an ACK/NAK bundling window is performed across both downlink subframes and spatial codewords. The method 700 ends in a step 725.

FIG. 8 illustrates a flow diagram of a method of operating a link interpretation unit, generally designated 800, carried out according to the principles of the present disclosure. The method 800 is for use in user equipment and starts in a step 805. Then, in a step 810, the user equipment is provided, and a hybrid ACK/NAK bundling operation is received from a base station, in a step 815. The hybrid ACK/NAK bundling operation for feeding back a corresponding uplink ACK/NAK entity to the base station is provided, in a step 820, wherein the hybrid ACK/NAK bundling operation corresponds to an uplink-downlink configuration of subframe assignments.

Generally, the hybrid ACK/NAK bundling operation consists of a pure ACK/NAK bundling, a pure multi-ACK/NAK or a combination of ACK/NAK bundling and multi-ACK/NAK. In one embodiment, an ACK/NAK bundling window is performed across downlink subframes corresponding to a single spatial codeword. In another embodiment, an ACK/NAK bundling window is performed across spatial codewords for single corresponding downlink subframes. In yet another embodiment, an ACK/NAK bundling window is performed across both downlink subframes and spatial codewords. The method 800 ends in a step 825.

While the methods disclosed herein have been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

Those skilled in the art to which the disclosure relates will appreciate that other and further additions, deletions, substitutions and modifications may be made to the described example embodiments without departing from the disclosure.

What is claimed is:

1. A link configuration unit, comprising:
a hybrid bundling module configured to provide a hybrid ACK/NAK bundling structure for an uplink ACK/NAK entity from user equipment, wherein the hybrid ACK/NAK bundling structure corresponds to an uplink-downlink configuration of subframe assignments; and
a sending module configured to transmit the hybrid ACK/NAK bundling structure to the user equipment.

2. The link configuration unit as recited in claim 1 wherein the hybrid ACK/NAK bundling structure consists of a pure ACK/NAK bundling, a pure multi-ACK/NAK or a combination of ACK/NAK bundling and multi-ACK/NAK.

3. The link configuration unit as recited in claim 1 wherein an ACK/NAK bundling window is performed across downlink subframes corresponding to a single spatial codeword.

4. The link configuration unit as recited in claim 1 wherein an ACK/NAK bundling window is performed across spatial codewords for single corresponding downlink subframes.

5. The link configuration unit as recited in claim 1 wherein an ACK/NAK bundling window is performed across both downlink subframes and spatial codewords.

6. A method of operating a link configuration unit, comprising:
providing a hybrid ACK/NAK bundling operation for an uplink ACK/NAK entity from user equipment, wherein the hybrid ACK/NAK bundling operation corresponds to an uplink-downlink configuration of subframe assignments; and
transmitting the hybrid ACK/NAK bundling operation to the user equipment.

7. The method as recited in claim 6 wherein the hybrid ACK/NAK bundling operation consists of a pure ACK/NAK bundling, a pure multi-ACK/NAK or a combination of ACK/NAK bundling and multi-ACK/NAK.

8. The method as recited in claim 6 wherein an ACK/NAK bundling window is performed across downlink subframes corresponding to a single spatial codeword.

9. The method as recited in claim 6 wherein an ACK/NAK bundling window is performed across spatial codewords for single corresponding downlink subframes.

10. The method as recited in claim 6 wherein an ACK/NAK bundling window is performed across both downlink subframes and spatial codewords.

11. A link interpretation unit, comprising:
a receiving module configured to receive a hybrid ACK/NAK bundling structure from a base station; and
a configuration reporting module configured to provide the hybrid ACK/NAK bundling structure for feeding back a corresponding uplink ACK/NAK entity to the base station, wherein the hybrid ACK/NAK bundling structure corresponds to an uplink-downlink configuration of subframe assignments.

12. The link interpretation unit as recited in claim 11 wherein the hybrid ACK/NAK bundling structure consists of a pure ACK/NAK bundling, a pure multi-ACK/NAK or a combination of ACK/NAK bundling and multi-ACK/NAK.

13. The link interpretation unit as recited in claim 11 wherein an ACK/NAK bundling window is performed across downlink subframes corresponding to a single spatial codeword.

14. The link interpretation unit as recited in claim 11 wherein an ACK/NAK bundling window is performed across spatial codewords for single corresponding downlink subframes.

15. The link interpretation unit as recited in claim 11 wherein an ACK/NAK bundling window is performed across both downlink subframes and spatial codewords.

16. A method of operating a link interpretation unit, comprising:
receiving a hybrid ACK/NAK bundling operation from a base station; and
providing the hybrid ACK/NAK bundling operation for feeding back a corresponding uplink ACK/NAK entity to the base station, wherein the hybrid ACK/NAK bundling operation corresponds to an uplink-downlink configuration of subframe assignments.

17. The method as recited in claim 16 wherein the hybrid ACK/NAK bundling operation consists of a pure ACK/NAK bundling, a pure multi-ACK/NAK or a combination of ACK/NAK bundling and multi-ACK/NAK.

18. The method as recited in claim 16 wherein an ACK/NAK bundling window is performed across downlink subframes corresponding to a single spatial codeword.

19. The method as recited in claim 16 wherein an ACK/NAK bundling window is performed across spatial codewords for single corresponding downlink subframes.

20. The method as recited in claim 16 wherein an ACK/NAK bundling window is performed across both downlink subframes and spatial codewords.
